(19) United States
(12) Patent Application Publication
(10) Pub. No.: US 2025/0281898 A1
(43) Pub. Date: Sep. 11, 2025

(54) METHOD FOR REMOVING AMMONIA FROM WASTEWATER

(71) Applicant: KING FAHD UNIVERSITY OF PETROLEUM AND MINERALS, Dhahran (SA)

(72) Inventors: Zuhair Omar MALAIBARI, Dhahran (SA); Ijaz HUSSAIN, Dhahran (SA); Basim Ahmed ABUSSAUD, Dhahran (SA)

(73) Assignee: KING FAHD UNIVERSITY OF PETROLEUM AND MINERALS, Dhahran (SA)

(21) Appl. No.: 18/595,615

(22) Filed: Mar. 5, 2024

(51) Int. Cl. B01J 20/20; B01J 20/02; B01J 20/28; B01J 20/32; C02F 1/28; C02F 101/16

(52) U.S. Cl. CPC B01J 20/205; B01J 20/0248; B01J 20/28004; B01J 20/28061; B01J 20/28064; B01J 20/28066; B01J 20/3204; B01J 20/3236; C02F 1/288; C02F 1/281; C02F 1/283; C02F 2101/16; C02F 2305/08

(57) ABSTRACT

A method for removing ammonia from wastewater including impregnating activated carbon with an aluminum salt to obtain an impregnated activated carbon. The impregnated activated carbon includes 8 to 12 weight percentage (wt. %) of Al based on the total weight of the Al and the activated carbon. The method further includes mixing the impregnated activated carbon with the wastewater while agitating at a temperature of 65 to 75° C. to contact the impregnated nanomaterial with the wastewater. During mixing the impregnated activated carbon with the wastewater, a first portion of the ammonia present in the wastewater is adsorbed on the impregnated activated carbon and a second portion of the ammonia present in the wastewater displaces a portion of the aluminum salt in the impregnated activated carbon.

### BACKGROUND

### Technical Field

The present disclosure is directed to a method of ammonia removal, and more particularly, directed to a method of removing ammonia from wastewater using a metal-impregnated activated carbon as an adsorbent.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention. Water is essential to the survival of all living things, and due to its extensive usage in agriculture, high-tech manufacturing, and energy generation, freshwater requires better management and sustainable use. Due to the rapid development of chemical and petroleum industries, many contaminants in industrial wastewater are becoming a significant issue of concern (see, Kahn & Malik., Environmental and health effects of textile industry wastewater, in Environmental Deterioration and Human Health: Natural and Anthropogenic, 55, 55-71 (Malik et al., eds., 2014)). It is estimated that 250,000 people per year lose their lives as a direct consequence of waterborne diseases. Different organic contaminants such as phenol, toluene, benzene, ethyl benzene, and the like are frequently found in water resources, especially groundwater. Similarly, heavy metals like arsenic (As), chromium (Cr⁺⁶), lead (Pb), and the like are also present in industrial wastewater, which may be fatal to human beings if consumed to a certain extent (see, Sankhala & Kumar, Contaminant of heavy metals in groundwater & its toxic effects on human health & environment, 18 Int'l J. Env't Sci. & Nat. Res. (2019)). One such contaminant in water is ammonia, a potential toxicant. Ammonia is an organic impurity in water due to organic anaerobic biological degradation of the nitrogenous compound. Further, due to the toxic nature of ammonia, the regulatory agencies set a maximum allowable limit of ammonia in drinking water. In addition, ammonia concentration should be decreased to avoid its adverse effect. If the limit of ammonia exceeds 50 parts per million (ppm) in the atmosphere, breathing problems may occur. Contamination levels above 50 to 100 ppm of ammonia may irritate the eyes, throat, and nausea. A common method for the removal of containments from water is by ion-exchange (see, Amini et al., Environmental and economic sustainability of ion exchange drinking water treatment for organics removal, 104 J. Cleaner Production (2015)). Similarly, methods like thermal desalination, membranes, and filtration are also adopted in water purification processes. However, in pollution treatment technology, it is essential to consider the most cost-effective technology. When the pollutant concentration is low, or the treatment required is to remove a single type of pollutant, the treatment technology becomes expensive. Hence, finding more cost-effective or economical water treatment technology becomes essential.

Adsorption is one of the techniques used to remove pollutants at a low cost with high efficiency in which the mass transfer on the solid adsorbent adsorbs the target containment. There is a plurality of adsorbent materials that are available in a variety of forms, shapes, and efficiencies. Ranging from biological adsorbents like leaf and rice husks to chemically engineered synthesized adsorbents like zeolite are used in water treatment for the removal of containments from water (see, Ali et al., Low-cost adsorbents for the removal of organic pollutants from wastewater, 113 J. Env't Mgmt. 170, 170-81 (2012)). In traditional adsorbent materials, the surface area plays a vital role in increasing the adsorption efficiency. In addition, the larger the surface area, the larger the adsorption rate. Adsorption operation exploits the ability of certain solids preferentially to concentrate specific substances from the solution onto their surface. Micro-materials like activated carbon (AC) and fly ash have proven to be alternative adsorbents for removing many compounds like, but not limited to, phenol, benzene, and toluene. AC has a large surface area ranging from 500 square meters per gram (m²/g) to 1500 m²/g, which helps in removing undesirable elements from wastewater (see, Sweetman et al., Activated carbon, carbon nanotubes, and graphene: materials and composites for advanced water purification, 3 J. Carbon Rsch. 1, 1-29 (2017)). Further, carbon nanotubes (CNTs) have extraordinary mechanical and electrical properties. One of the most important properties of these nano-structured CNTs is their high surface area. CNTs are also used to see the effect on the removal efficiency of ammonia from water (see, Reverchon & Adami, Nanomaterials and supercritical fluids, 37 J. Supercritical Fluids 1, 1-22 (2006)).

Although several adsorbents have been used in the past for water treatment processes, most of the conventionally used adsorbents are expensive. Hence, cost-effective, and sustainable solutions to remove ammonia from water are still needed. Accordingly, an object of the present disclosure is directed to removing ammonia from wastewater in a cost-effective and a sustainable manner.

### SUMMARY

In an exemplary embodiment, a method for removing ammonia from wastewater is described. The method includes impregnating activated carbon with an aluminum salt to obtain an impregnated activated carbon. The impregnated activated carbon comprises 8 to 12 weight percentage (wt. %) of Al and the wt. % is based on the total weight of the Al and the activated carbon. Moreover, the Al present in the impregnated activated carbon is in the form of nanocrystals and the crystals are at least partially embedded in the activated carbon and the wastewater has a pH between 9 and 11. The method further includes mixing the impregnated activated carbon with the wastewater while agitating at a temperature of 65 to 75° C. to contact the impregnated nanomaterial with the wastewater. During mixing the impregnated activated carbon with the wastewater, a first portion of the ammonia present in the wastewater is adsorbed on the impregnated activated carbon and a second portion of the ammonia present in the wastewater displaces a portion of the aluminum salt in the impregnated activated carbon.

In some embodiments, 0.05 to 2.0 gram (g) of the impregnated activated carbon is mixed with 100 milliliters (mL) of the wastewater.

In some embodiments, the Al nanocrystals have a diameter of 50 to 600 nanometers (nm). In some embodiments, the impregnated activated carbon and the wastewater are mixed with an agitation speed of 100 to 250 rotations per minute (RPM).

In some embodiments, the impregnated activated carbon comprises 10 wt. % Al, the mixing achieves an ammonia removal of 40 wt. % from the wastewater based on the total weight of the wastewater, the pH of the wastewater during the mixing is 10.5, and the mixing is conducted for 2 hours.

In some embodiments, 5% to 40% by volume of the Al nanocrystals are embedded in the activated carbon.

In some embodiments, the aluminum salt is aluminum nitrate.

In some embodiments, the activated carbon has an average particle diameter of 600 to 1000 nm.

In some embodiments, the mixing is at an agitation speed of 200 RPM.

In some embodiments, the impregnated activated carbon comprises 10 wt. % of Al.

In some embodiments, the wastewater has a pH of 10 to 11.

In some embodiments, the wastewater has a pH of 10.5.

In some embodiments, the impregnated activated carbon has a top surface and a bottom surface, the top and bottom surface are irregular in shape, and the impregnated activated carbon has a surface area of 500 to 1500 square meters per gram (m²/g).

In some embodiments, the wastewater has a temperature of 70° C. during the mixing.

In some embodiments, 1.5 to 2 g of the impregnated activated carbon is mixed with the wastewater.

In some embodiments, 2 g of the impregnated activated carbon is mixed with the wastewater.

In some embodiments, the method includes mixing the impregnated activated carbon with the wastewater for 2 to 4 hours.

In some embodiments, the method includes mixing the impregnated activated carbon with the wastewater for 2 hours.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a field emission scanning electron microscopy (FESEM) image of activated carbon (AC) with 1 wt. % silver (Ag), according to certain embodiments.

FIG. 1B is an FESEM image of the AC with 10 wt. % iron (Fe), according to certain embodiments.

FIG. 1C is an FESEM image of the AC with 10 wt. % copper (Cu), according to certain embodiments.

FIG. 1D is an FESEM image of pure carbon nanotubes (CNTs), according to certain embodiments.

FIG. 1E is an FESEM image of the CNTs with 10 wt. % Ag, according to certain embodiments.

FIG. 1F is an FESEM image of the CNTs with 10 wt. % aluminium (Al), according to certain embodiments.

FIG. 2A depicts thermogravimetric analysis (TGA) thermogram of CNTs impregnated with iron (II) oxide (FeO), according to certain embodiments.

FIG. 2B is a TGA thermogram of CNTs impregnated with aluminum oxides (AIO), according to certain embodiments.

FIG. 2C is a TGA thermogram of AC impregnated with AIO, according to certain embodiments.

FIG. 2D is a TGA thermogram of AC impregnated with copper (II) oxide (CuO), according to certain embodiments.

FIG. 3A is a depicts the effect of pH on ammonia removal using the AC with various metal impregnations, according to certain embodiments.

FIG. 3B depicts the effect of pH on ammonia removal using the CNTs with various metal impregnations, according to certain embodiments.

FIG. 4A depicts the effect of agitation speed on ammonia removal using the AC impregnated with various metals, with 1 wt. % metal loading, according to certain embodiments.

FIG. 4B depicts the effect of agitation speed on ammonia removal using the AC impregnated with various metals, with 10 wt. % metal loading, according to certain embodiments.

FIG. 4C depicts the effect of agitation speed on ammonia removal using the CNTs impregnated with various metals, with 1 wt. % metal loading, according to certain embodiments.

FIG. 4D depicts the effect of agitation speed on ammonia removal using the CNTs impregnated with various metals, with 10 wt. % metal loading, according to certain embodiments.

FIG. 5A depicts the effect of dosage of adsorbent on ammonia removal using the AC impregnated with various metals, with 1 wt. % metal loading, according to certain embodiments.

FIG. 5B depicts the effect of dosage of adsorbent on ammonia removal using the AC impregnated with various metals, with 10 wt. % metal loading, according to certain embodiments.

FIG. 5C depicts the effect of dosage of adsorbent on ammonia removal using the CNTs impregnated with various metals, with 1 wt. % metal loading, according to certain embodiments.

FIG. 5D depicts the effect of dosage of adsorbent on ammonia removal using the CNTs impregnated with various metals, with 10 wt. % metal loading, according to certain embodiments.

FIG. 6A depicts the effect of contact time on ammonia removal using the AC impregnated with various metals, with 1 wt. % metal loading, according to certain embodiments.

FIG. 6B depicts the effect of contact time on ammonia removal using the AC impregnated with various metals, with 10 wt. % metal loading, according to certain embodiments.

FIG. 6C depicts the effect of contact time on ammonia removal using the CNTs impregnated with various metals, with 1 wt. % metal loading, according to certain embodiments.

FIG. 6D depicts the effect of contact time on ammonia removal using the CNTs impregnated with various metals, with 10 wt. % metal loading, according to certain embodiments.

FIG. 7A depicts the effect of temperature on ammonia removal using the AC impregnated with various metals, with 1 wt. % metal loading, according to certain embodiments.

FIG. 7B depicts the effect of temperature on ammonia removal using the AC impregnated with various metals, with 10 wt. % metal loading, according to certain embodiments.

FIG. 7C depicts the effect of temperature on ammonia removal using the CNTs impregnated with various metals, with 1 wt. % metal loading, according to certain embodiments.

FIG. 7D depicts the effect of temperature on ammonia removal using the CNTs impregnated with various metals, with 10 wt. % metal loading, according to certain embodiments.

FIG. 8 is a schematic illustration of a mechanism of removal pathways of ammonia from wastewater using adsorbents, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

The present disclosure is intended to include all hydration states of a given compound or formula, unless otherwise noted or when heating a material.

Aspects of the present disclosure are directed at removing ammonia from wastewater using adsorbents, activated carbon (AC), and carbon nanotubes (CNTs). The properties of AC and CNTs were altered by impregnating them with metals such as Fe, Al, Ag, and Cu in different ratios (1-10 wt. %). The effect of pH, contact time, agitation speed, dosage, and temperature on the performance of the impregnated adsorbents on ammonia removal was evaluated. The results indicate that at pre-determined conditions, the method of the present disclosure effectively removes at least 40% ammonia from the wastewater demonstrating that the adsorbents of the present disclosure can be used for water pre-treatment processes.

Wastewater refers to water contaminated with human waste, fats, oil, grease, solids, organic contaminants, nutrients, pathogens, and the like generated in residential homes, commercial businesses, industrial facilities, municipal facilities, agricultural facilities, and the like. The order in which the method is described is not intended to be construed as a limitation, and any number of the described method steps can be combined in any order to implement the method. Additionally, individual steps may be removed or skipped from the method without departing from the spirit and scope of the present disclosure.

The method includes impregnating activated carbon with an aluminum salt to obtain an impregnated activated carbon. Activated carbon is an adsorbent that is conventionally known in the art for the removal of ammonia from wastewater. In an embodiment, the activated carbon has particles of various sizes—for example, 605, 610, 615, 620, 625, 630, 635, 640, 645, 650, 655, 660, 665, 670, 675, 680, 685, 690, 695, 700, 705, 710, 715, 720, 725, 730, 735, 740, 745, 750, 755, 760, 765, 770, 775, 780, 785, 790, 795, 800, 805, 810, 815, 820, 825, 830, 835, 840, 845, 850, 855, 860, 865, 870, 875, 880, 885, 890, 895, 900, 905, 910, 915, 920, 925, 930, 935, 940, 945, 950, 955, 960, 965, 970, 975, 980, 985, 990, 995, and 1000 nm, with the average particle diameter of 600 to 1000 nm.

In some embodiments, carbon nanotubes (CNTs) may be used as an adsorbent as well, alone or in combination with the activated carbon. The CNTs have a diameter in the range of 20 to 40 nm, including particles of various sizes—for example, 21, 22, 23, 24, 25, 26, 27, 28, 29, 30, 31, 32, 33, 34, 35, 36, 37, 38, 39 and 40 nm, with the average diameter preferably if about 24 nm. Although the description herein provided refers to the use of activated carbon as a preferred choice of adsorbent, in some embodiments, the CNTs may be used as well as the adsorbent, albeit with a few variations, as may be obvious to a person skilled in the art. In some other embodiments, adsorbents like fly ash and carbon nanofibers may be used as well, alone or in combination with the activated carbon/CNTs.

The adsorbent, preferably activated carbon, is mixed with a metal salt, preferably an aluminum salt, to form impregnated activated carbon. Suitable examples of aluminum salts include, but are not limited to, aluminum sulfate, aluminum nitrate, aluminum chloride, aluminum acetate, aluminum carbonate, aluminum phosphate, and/or a hydrate thereof. In a preferred embodiment, the aluminum salt is aluminum nitrate. The weight ratio of the aluminum salt to the activated carbon is in the range of 1:1 to 1:10, preferably 1:1, 1:2, 1:3, 1:4, 1:5, 1:6, 1:7, 1:8, 1:9, and more preferably 1:10.

In some embodiments, the aluminum salt may be dissolved in a solvent prior to mixing the activated carbon with the aluminum salt. The solvent may be organic or aqueous. In a preferred embodiment, the solvent is an organic solvent. Suitable examples of the organic solvent include, but are not limited to, tetrahydrofuran, ethyl acetate, dimethylformamide, acetonitrile, acetone, dimethyl sulfoxide, nitromethane, propylene carbonate, ethanol, formic acid, n-butanol, methanol, or any combination thereof. In some embodiments, the organic solvent may include benzene, cyclohexane, ethanol, methanol, acetone, ethyl acetate, dichloromethane, toluene, and diethyl ether. In a preferred embodiment, the solvent is an alcohol, preferably ethanol.

In some embodiments, the activated carbon may be impregnated with other metal salts such as iron salt, silver salt, copper salt, and/or a combination thereof. Suitable examples of iron salt include, but are not limited to, ferrous sulfate, ferrous gluconate, ferrous nitrate hexahydrate, ferrous fumarate, ferrous chlorate, ferrous oxide, ferrous iodide, ferric chloride, ferric nitrate, ferric sulfate, and/or combinations thereof. In a preferred embodiment, the iron salt is ferric nitrate. Suitable examples of copper salt include copper (I) salts such as copper oxide, copper chloride, copper sulfate, copper bromide, copper nitrate, copper iodide, and copper t-butoxide, copper (II) salts such as copper sulfate, copper chloride, copper nitrate, copper acetate, copper carbonate, copper phosphate, copper (III) salts, or any combinations thereof. In an embodiment, the copper salt is copper (III) nitrate. Silver salts include silver sulfate, silver acetate, silver fluoride, silver chloride, silver bromide, silver iodide, silver cyanide, silver cyanate, silver carbonate, silver perchlorate or their hydrate, or mixtures thereof. In a specific embodiment, the silver salt is silver nitrate. In a preferred embodiment, the silver salt is silver nitrate. In some embodiments, metal carbides and/or metal nitrides of Zn (zinc) and Ti (titanium) may be used as well to impregnate the activated carbon. In each of these embodiments, the metal salt of copper/silver/iron and/or combinations thereof may be dissolved in the solvent prior to mixing it with the activated carbon.

An alcoholic solution, preferably ethanolic solution, of the metal salt, preferably aluminum salt, is mixed with the activated carbon, to form a mixture. The preferred mode of mixing may be via sonication, although agitation, stirring, or other conventional methods may be employed as well. The sonication was carried out to ensure proper dispersion of the metal salt on the activated carbon. In some embodiments, the sonication is carried out for 10-60 minutes, preferably 20-50 minutes, preferably 30-40 minutes, preferably 30 minutes. Sonication is further carried out at a frequency range of 10-50 KHz, preferably 20-45 KHz, preferably 30-40 KHz, preferably 40 KHz. The mixture may be further heated to a temperature range of 60-120° C., preferably to a temperature slightly higher than the boiling point of the preferred solvent, to evaporate the solvent. In a preferred embodiment, the mixture is heated to a temperature of about 70-80° C., after which the mixture may be dried for 12 to 48 hours, preferably 16 to 36 hours, preferably 20 to 30 hours, and preferably 24 hours. In some embodiments, the drying can be performed by using heating appliances such as ovens, microwaves, autoclaves, hot plates, heating mantles and tapes, oil baths, salt baths, sand baths, air baths, hot-tube furnaces, and hot-air guns. The mixture is further calcined in a furnace at about 300° C., about 310° C., about 320° C., about 330° C., about 340° C., and about 350° C., for 2 to 4 hours, preferably 3 hours, to form the impregnated activated carbon. The impregnated activated carbon has a surface area of 500 to 1500 m²/g.

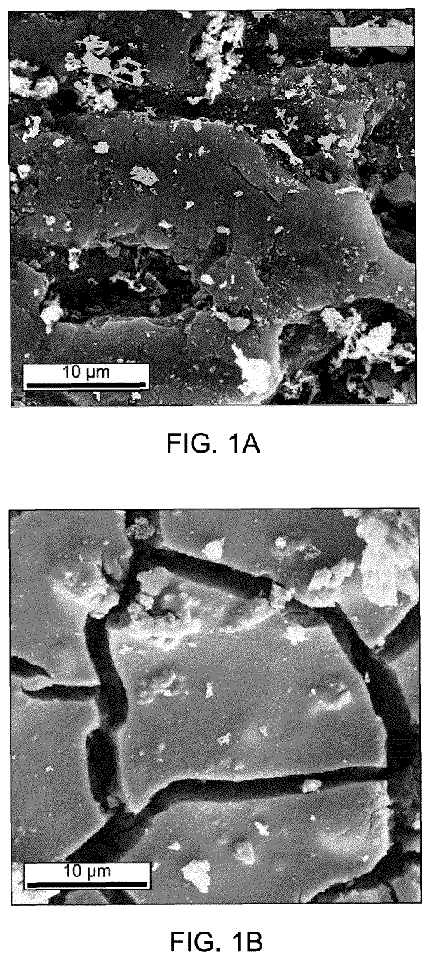

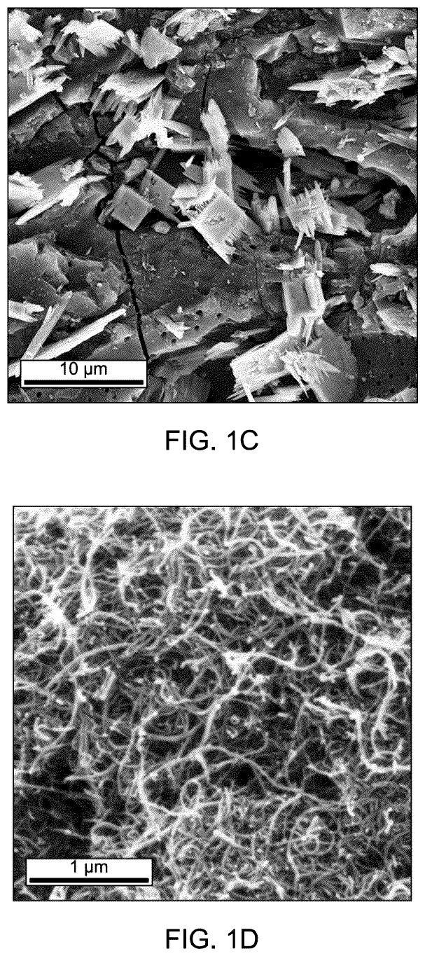

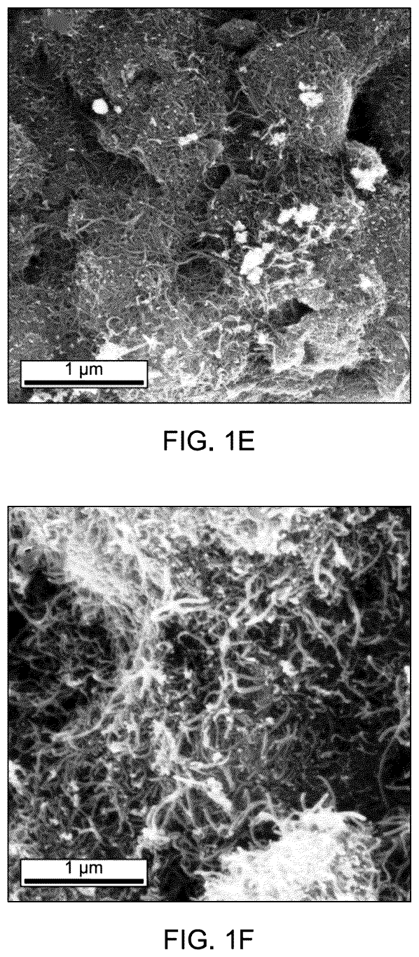

The impregnated activated carbon includes aluminum nanoparticles impregnated, at least partially, on and/or in the activated carbon. In some embodiments, at least 5 to 40% by volume of the nanocrystals, preferably 5%, preferably 10%, preferably 15%, preferably 20%, preferably 25%, preferably 30%, preferably 35%, preferably 40% of the activated carbon is impregnated with the aluminum nanoparticles. The existence of impregnated material in addition to raw CNTs and AC was confirmed by obtaining TGA and DTG curves for all adsorbents at a heating rate of 10° C./min. The nanocrystals on the surface of the impregnated activated carbon were seen by Field Emission Scanning Electron Microscopy (FESEM), as seen in FIGS. 1A-1F. In some embodiments, the impregnated activated carbon has a top surface and a bottom surface. The top and bottom surfaces are irregular in shape due to the presence of aluminum nanoparticles dispersed on its surface. The weight percentage of aluminum nanoparticles in the impregnated activated carbon is preferably in the range of 8-12 wt. %, preferably 9-11 wt. %, preferably 10 wt. % based on the total weight of the Al and the activated carbon. The aluminum nanoparticles may exist in various morphological shapes, such as nanowires, nanocrystals, nanorectangles, nanosheets, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof. In some embodiments, the Al nanocrystals have a diameter of 50 to 600 nm.

The method includes mixing the impregnated activated carbon with the wastewater while agitating at a temperature of 65-75° C., preferably 70° C., to contact the impregnated nanomaterial with the wastewater. In some embodiments, about 0.05 to 2.0 g, preferably 0.1 g, preferably 0.2 g, preferably 0.3 g, preferably 0.4 g, preferably 0.5 g, preferably 0.6 g, preferably 0.7 g, preferably 0.8 g, preferably 0.9 g, preferably 1 g, preferably 1.1 g, preferably 1.2 g, preferably 1.3 g, preferably 1.4 g, preferably 1.5 g, preferably 1.6 g, preferably 1.7 g, preferably 1.8 g, preferably 1.9 g, and more preferably about 2 g of the impregnated activated carbon is mixed with 100 mL of the wastewater. The wastewater may be acidic or basic, preferably basic in nature. In an embodiment, the wastewater has a pH in a range of 9-11, preferably 9, preferably 9.5, preferably 10, preferably 10.5, and preferably about 11. The impregnated activated carbon and the wastewater are mixed with an agitation speed of 100 to 250 RPM, preferably 100 RPM, preferably 120 RPM, preferably 140 RPM, preferably 160 RPM, preferably 180 RPM, preferably 200 RPM, preferably 220 RPM, preferably 240 RPM, with a preferred agitation speed of about 200 RPM. In some embodiments, the impregnated activated carbon and the wastewater are mixed for 2-4 hours, preferably 2 hours. During mixing, a first portion of the ammonia present in the wastewater is adsorbed on the impregnated activated carbon, and a second portion of the ammonia present in the wastewater displaces a portion of the aluminum salt in the impregnated activated carbon. In a specific embodiment, when the impregnated activated carbon includes 10 wt. % Al, with the pH of the wastewater around 10.5, and when the mixing is performed for 2 hours about 40 wt. % of ammonia is removed from the wastewater based on the total weight of the wastewater.

### EXAMPLES

The following examples demonstrate a method for removing ammonia from wastewater using a metal-impregnated activated carbon. The examples are provided solely for illustration and are not to be construed as limitations of the present disclosure, as many variations thereof are possible without departing from the spirit and scope of the present disclosure.

### Example 1: Preparation of Impregnated Materials

To prepare 20 grams (g) of impregnated material, a stoichiometric amount of chemical salts, including ferric nitrate, aluminum nitrate, silver nitrate, and copper (III) nitrate, was measured by using the Mettler Toledo balance. Each sample was mixed in 200 milliliters (ml) of 98% pure ethanol in a beaker until completely dissolved. Carbon nanotubes (CNTs) and activated carbon (AC) were measured as 19.8 g for 1% impregnation and 18 g for 10% impregnation and then added to the beaker containing ethanol and salts. The beaker was sonicated for 30 minutes (min) at an amplitude of 40 KHz for proper dispersion of impregnation materials on CNT and AC. After sonication, the mixture was kept in the oven for 24 hours at 70° C. to evaporate ethanol. The mixture was kept in the furnace for 3 hours at 350° C. for calcination. Finally, the materials were characterized to ensure proper impregnation of materials on CNTs and AC.

### Example 2: Characterization of Adsorbents

Field emission scanning electron microscopy (FESEM), thermogravimetric analysis (TGA), and X-ray diffraction (XRD) analysis were utilized to characterize the various absorbents that confirm the morphology of the adsorbents. FESEM was used to characterize the length and diameter of CNTs and AC. The existence of impregnated material in addition to raw CNTs and AC was confirmed by obtaining TGA and derivative thermogravimetric (DTG) curves for all adsorbents at a heating rate of 10 degrees Celsius per minute (° C./min).

### Example 3: Preparation of Ammonia Stock Solution

A commercially available ammonia solution with a purity of 30% was used to form a stock solution with a concentration of 300 parts per million (ppm). To prepare 300 ppm stock solution, 2 ml of 30% ammonia solution was pipetted to a 2000 ml flask with constant stirring. The pH of the stock solution was adjusted by using 1.0 molar (M) hydrochloric acid (HCl) for acidic media and 1.0 M sodium hydroxide (NaOH) for basic media.

### Example 4: FESEM Analysis

A plurality of absorbents were subjected to FESEM analysis to study morphological changes. The presence of crystals on the surface of these carbon absorbents is due to the presence of certain trace metals. These traces, which can be seen in the FESEM images, are evidence that additional species such as copper (Cu), aluminum (Al), iron (Fe), and silver (Ag) particles have been impregnated onto the CNTs and AC surfaces. This has resulted in an alteration of the surface morphology due to the aggregation of different metals, as illustrated in FIGS. 1A-1F. The diameter of CNTs may range from 20 to 40 nanometers (nm), with an average diameter of 24 nm and a length of a few microns, while AC exhibited a diameter range of between 600 and 1000 microns on average, which may be expanded by various impregnations.

### Example 5: TGA Results

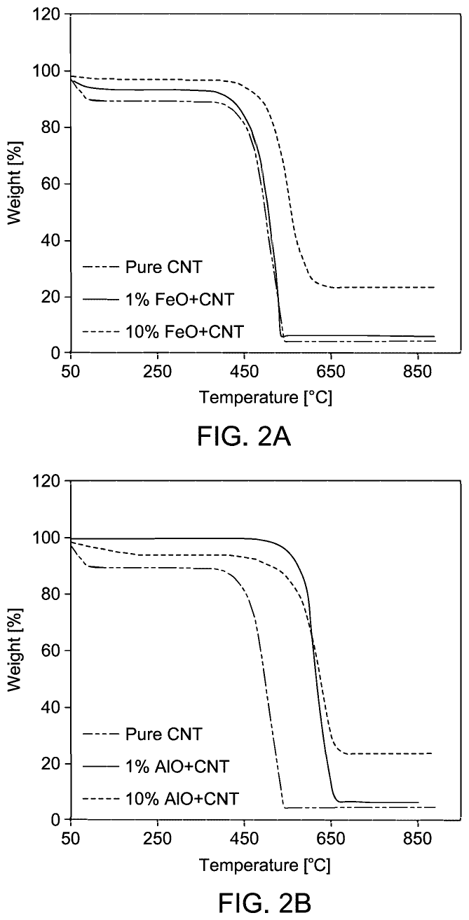

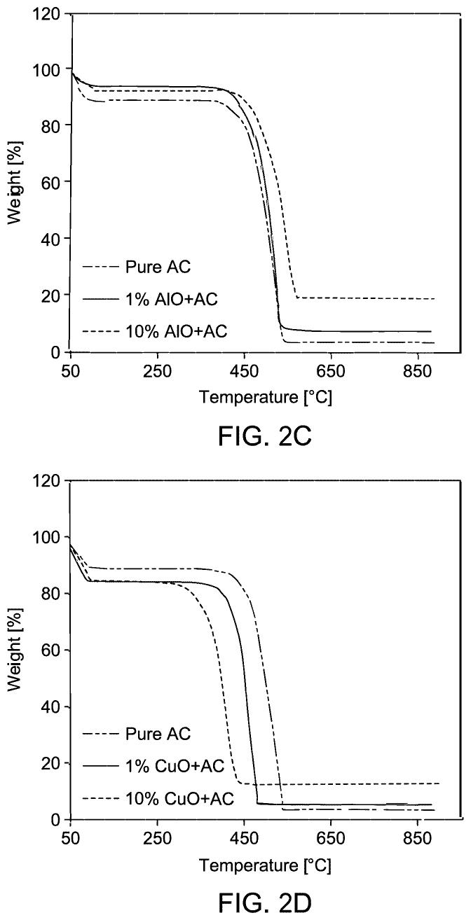

TGA is a thermal analysis technique that generally confirms surface morphology by increasing temperature at a constant rate. In the present TGA analysis, all samples were heated at a constant rate of 10° C./min in the presence of air up to 900° C. Due to heating, CNTs and AC were oxidized. However, some residuals were left in the pan, indicating trace metal-like reddish ash in case of Fe impregnation. Additionally, the decomposition of CNTs is a single-stage decomposition reaction. As can be seen in FIG. 2A, for 10% loading, the initial degradation started at approximately 450° C., followed by a sharp decline, indicating a rapid weight loss from 450° C. to 530° C. (designated as 10% FeO+CNT). Further, when the temperature reached 900° C., the weight loss was close to 20%. This result is then compared to the pure CNTs. It was found that 10% loading with more ash in the pan confirms the presence of Fe impregnation. Similarly, 1% metal loading is also displayed for comparison (designated as 1% FeO+CNT. This loading level followed the same trend when the temperature increased, but a smaller quantity of ash was left in the pan than when 10% loading was used.

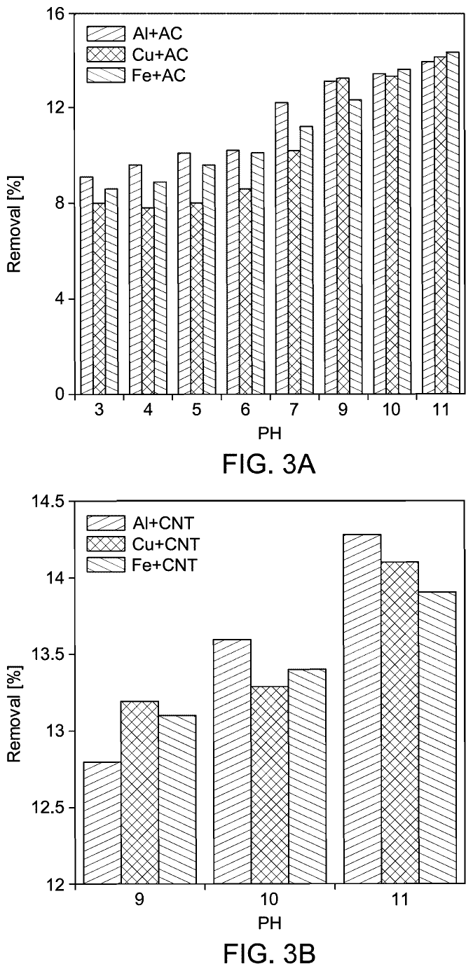

As can be seen from FIG. 2B, a similar trend was noticed. Pure CNTs are compared with 1% (designated as 1% AlO+CNT) and 10% (designated as 10% AlO+CNT) loading of Al material. A higher value in the 10% loading at the flat end demonstrates that some Al is present in the pan, confirming the existence of the impregnated material. As CNT and AC belong to the same carbon family, the trend in TGA results for both was similar. AC has also shown a gradual degradation in weight percentage (wt. %) until it reaches 450° C., whereas a sharp loss in wt. % was noticed till 530° C. When comparing pure AC with 1% and 10% loading of various materials, the results showed that with 10% loading, the wt. % at the end was always higher, as illustrated in FIGS. 3C-3D. This indicates the impregnation of material because a higher proportion of material remained in the pan after the process.

### Example 6: Removal of Ammonia from Industrial Wastewater

In addition to raw AC and pure CNTs, the materials were further enhanced by impregnating with four different metals to see their effect on ammonia removal. Many parameters, including changes in dosage, contact time, agitation speed, pH, and temperature, were varied to determine the appropriate conditions for ammonia removal. The initial concentration of ammonia stock solution was around 200 parts per million (ppm). The removal percentage of ammonia and the adsorption capacity of the adsorbent were then calculated.

### Example 7: Effect of pH

Aqua ammonia is classified as a weak base. In aqua solution, total ammonia exists in two forms: ionized form (NH⁴⁺) and unionized form (NH₃). It is pH dependent, and the equilibrium equation is governed by,

$${NH}_{3} + {H}_{2} O ↔ {NH}_{4}^{+} + {OH}^{-}$$

$${K}_{a} = \frac{[ {NH}_{3} ] [ {H}^{+} ]}{[ {NH}_{4}^{+} ]} = 1.8 \times 1 {0}^{- 5} at 25 ° C .$$

At high pH, the solution is more basic. Therefore, the equation moves to the left side, and when pH is low, the equation moves to the right. The investigation of the removal of unionized ammonia where the first set of experiments was conducted at 25° C. with 200 RPM and a contact time of 2 hours. The pH value varied from 3 to 11, but according to unionized and ionized ammonia ranges, only pH values from 9 to 11 were considered for determining the preferred conditions for ammonia removal. At a pH value of 11.5 and above, the ammonium hydroxide ion is converted to ammonia gas, so the solution's natural pH, which was 10.5, was considered the preferred pH value. As can be seen from FIGS. 3A-3B, pH does not have much effect on the removal percentage, as between 9 and 11, the removal percentage of ammonia is negligible, which may be considered constant. When the removal efficacy of AC and CNTs with various metal impregnations was investigated, it was observed that AC was more efficient than CNTs.

### Example 8: Effect of Agitation Speed

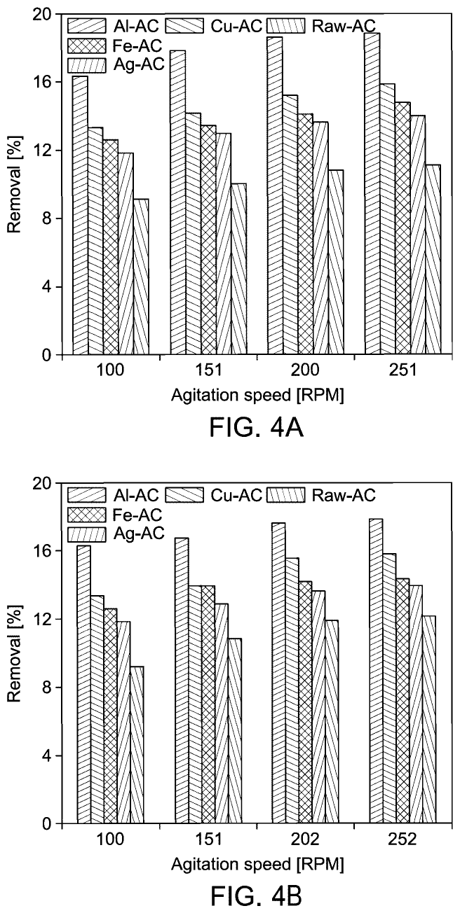

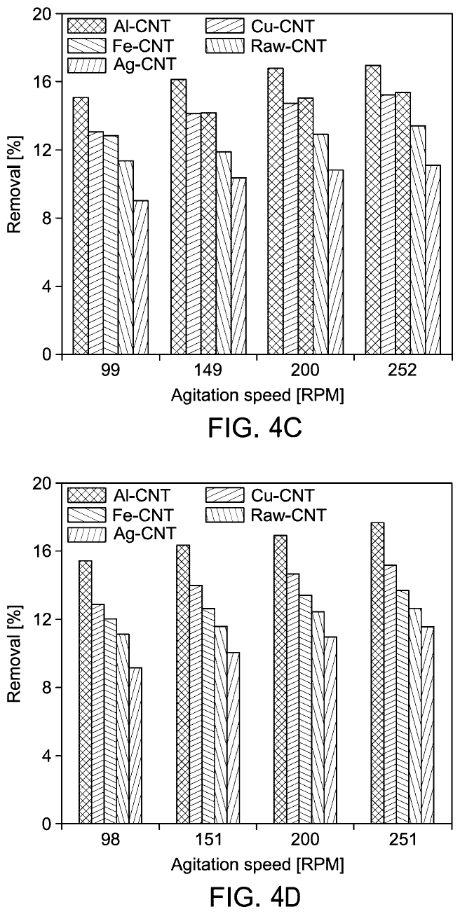

The pH, dosage, temperature, and contact time values were fixed at 10.5, 1 g, 25° C., and 2 hours, respectively. As shown in FIGS. 4A-4D, varying the agitation speed from 100 to 250 RPM, resulted in an increased percentage of ammonia removal with the increase in agitation speed. After 200 RPM, the adsorption capacity and removal efficiency show equilibrium behavior. AC and CNTs have shown similar behavior, but the overall removal efficiency of AC and its modified versions was higher than that of its corresponding CNTs.

The effect of diffusion of ammonia molecules on the surface of the adsorbent is an important phenomenon associated with this removal percentage with increasing agitation speed while keeping other parameters constant. The main resistance for ammonia molecules to adsorb is the H⁺ and OH⁻ ions. When the shaking speed increases, they have more chance to contact the surface binding sites, and hence, the removal of ammonia increases. External mass transfer is a strong function of surface contact, which is increased by the increasing shaking speed. From the results, it was concluded that 200 RPM is the preferred condition for maximum removal. Different adsorbents show different removal percentages based on their active site binding properties. AC and CNTs were used in their pure state (commercially available) to compare the baseline. Two different loadings, 1% and 10% of impregnation material, were considered. As can be seen from FIGS. 4A-4B, Al impregnation onto AC has given the highest removal. After that, Fe and Cu showed better results than pure AC and Ag impregnation. Further, as can be seen from FIG. 4B, 10% loading of material has shown better results than 1% loading due to more modified active sites on the surface of AC. Furthermore, as can be seen from FIG. 4D, similar behavior is noticed by CNTs and their modified forms, but its removal efficiency is lower than AC.

### Example 9: Effect of Adsorption Dosage

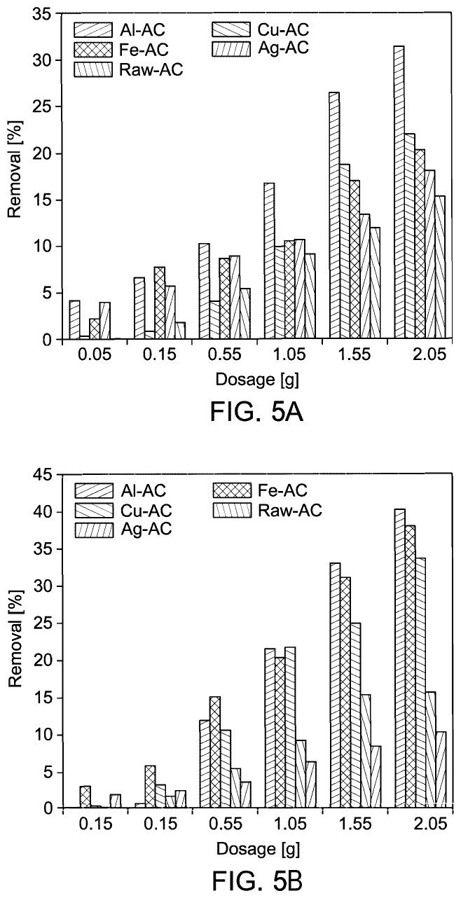

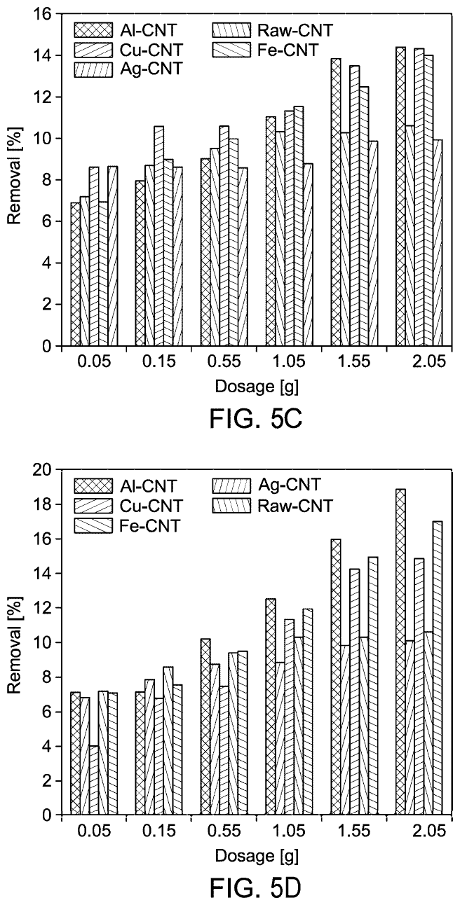

Keeping other parameters constant, such as pH, contact time, agitation speed, and temperature, at 10.5, 2 hours, 200 RPM, and 25° C., respectively, adsorption dosage was varied to investigate its effect on ammonia removal. With the increase in the dosage amount of adsorption, more active sites were available for the molecule to bind with; hence, this increased the exchangeable site for ions. As can be seen from FIGS. 5A-5D, 0.05 g and 0.1 g has shown low removal results. This is because a small dosage is insufficient to remove a high concentration of ammonia at 200 ppm.

With the increase in dosage, it was noticed that the removal efficiency started to increase because of the availability of more active sites. Among the activated carbon and its modified version, 10% Al-impregnated AC, as shown in FIG. 5B, produced the best result with a removal percentage of 40.3%, followed by Fe impregnation of 37.8% and then Cu for 33.5% at a 2 g dosage of adsorbent. Pure and Ag-impregnated AC showed much lower results than others. A similar trend was also noticed by CNTs for both 1% and 10% loading. When comparing 1% and 10% loadings of metal, 10% showed better removal results. As can be seen from FIGS. 5A-5D, even at a high dosage of 2 g in 100 ml stock solution, the trend does not show equilibrium behavior and tends to give higher removal by increasing dosage. But from an economic point of view in industries, this dosage amount may be multiplied many times on a larger scale, which might not be economically viable; hence, for experimental investigation, the preferred condition, 1 g adsorbent, was considered.

### Example 10: Effect of Contact Time

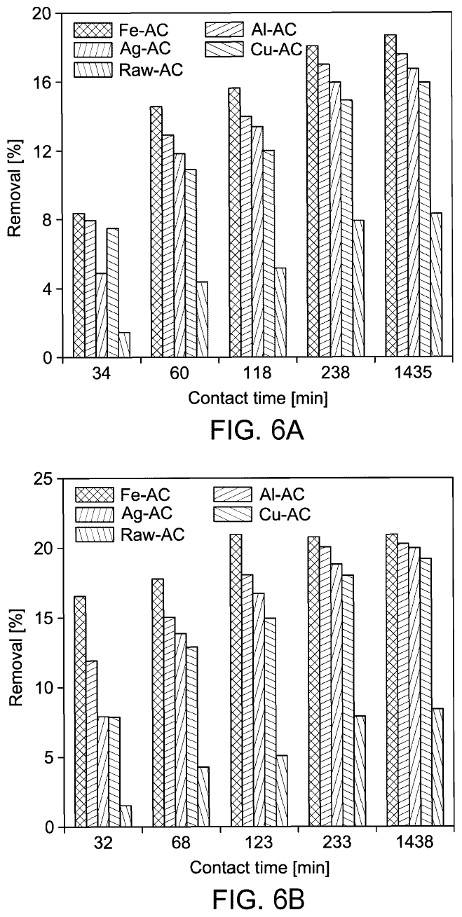

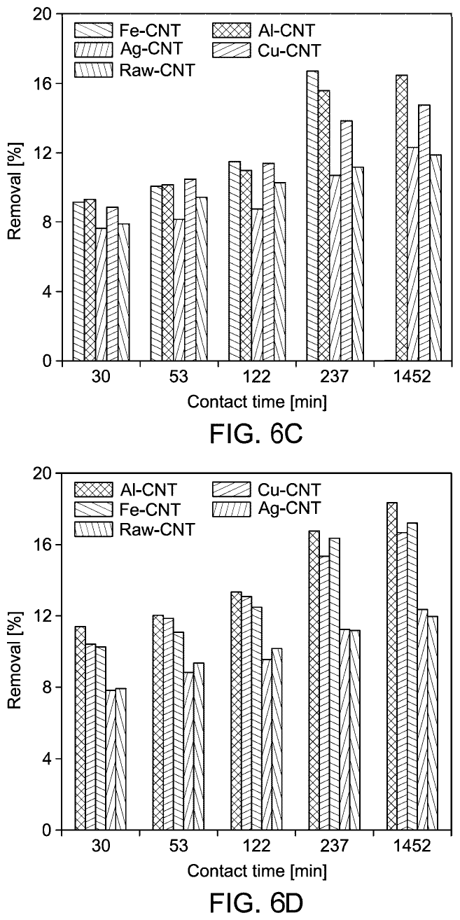

The effect of contact time was investigated at different intervals by keeping the pH, agitation speed, temperature, and dosage constant at 10.5, 200 RPM, 25° C., and 1 g, respectively. The time interval for contact between adsorbate and adsorbent was varied as 30 min, 60 min, 120 min, 240 min, and 1440 min. As can be seen from FIGS. 6A-6D, adsorption rapidly increases in the first 2 hours, and then the trend showed a slow removal percentage between 2 hours and 4 hours until becoming constant for the 1440 min period. It can also be seen that 1% and 10% loading of AC showed much better results than the pure AC. Fe impregnation showed higher removal, followed by Al impregnation. For CNTs, the overall removal percentage was lower than AC for fixed loadings (1% or 10%), as illustrated in FIGS. 6C-6D. Pure and impregnated CNTs showed similar results, as AC with Al and Fe showed higher removal. Adsorbents and pollutants were allowed into contact for a longer period, which allowed them to have more surface exposure, and eventually, this phenomenon increased the overall removal of ammonia. With the increase in time, more than 4 hours, the adsorbent gets saturated, and the equilibrium starts to establish. 2 hours of contact time between the pollutant and adsorbent was preferred for further study.

### Example 11: Effect of Temperature

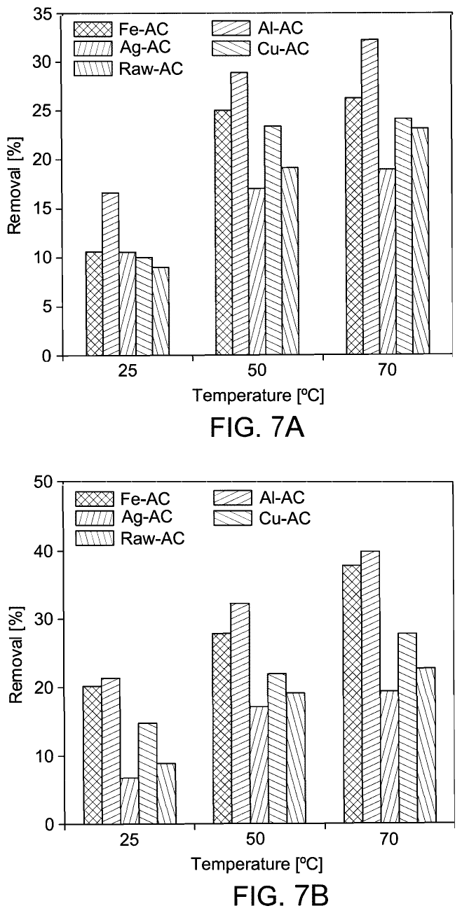

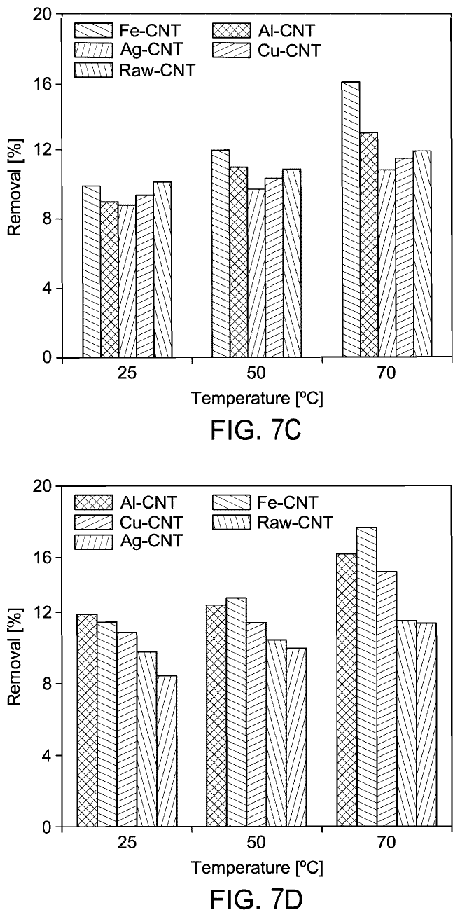

The temperature was raised in the range of 25° C. to 70° C. Other parameters, such as pH, dosage, contact time, and agitation speed, were kept constant at 10.5, 1 g, 2 hours, and 200 RPM, respectively. The increased frequency of molecular movement may give ammonia molecules more chances to interact with the adsorption surface. More active sites are accessible with increasing temperature due to the increased movement of molecules, increasing the removal percentage. Further, with the increasing temperature, the resistance of water's H⁺ and OH-ions is less, which increases external mass transfer. As can be seen from FIGS. 7A-7D, at a temperature of 25° C., the removal was within the range of 10% to 17%. However, with the increase of temperature from 25° C. to 50° C. and finally to 70° C., the removal efficiency of AC increases to a maximum of 32%. Al and Fe impregnation showed better results than pure and Ag impregnation. In the case of CNT, when the temperature was increased from 25° C. to 50° C., the trend showed slow removal as compared to the trend from 50° C. to 70° C. Loadings of 10% showed better removal results than 1%, as shown in FIG. 7B and FIG. 7D.

### Example 12: Mechanism of Removal of Ammonia from Wastewater

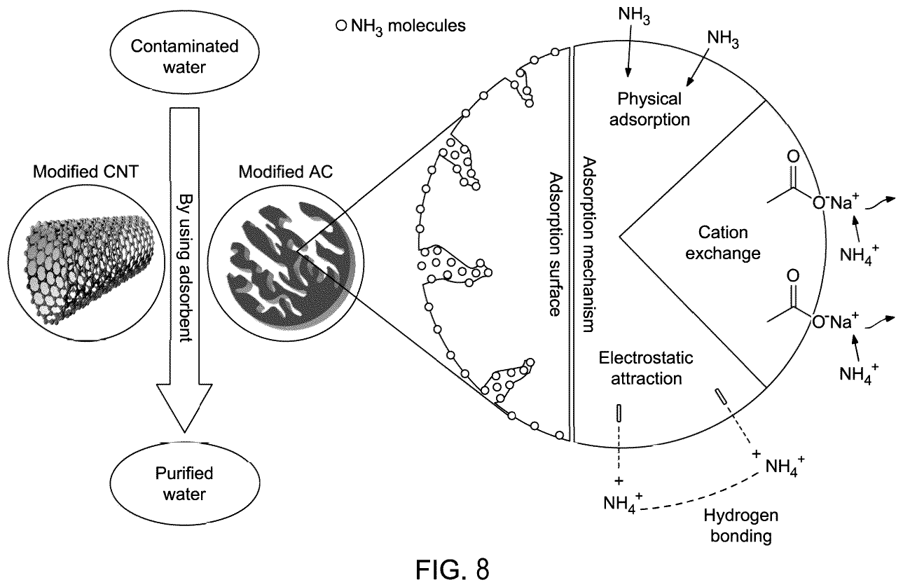

As seen in FIG. 8, the removal pathways of ammonia from wastewater by adsorbents are explained. The adsorption of ammonia nitrogen by modified AC and CNTs was mainly physical adsorption. This was demonstrated by the liquid film diffusion and micropore diffusion process of NH₄⁺ on the surface of modified AC and CNTs. At the same time, chemical adsorption of NH₄⁺ also occurred (see, Ren et al., Study on adsorption of ammonia nitrogen by iron-loaded activated carbon from low temperature wastewater, Chemosphere (2021)—incorporated herein by reference in its entirety). After modification, the quantity of OH⁻ on the surface of the AC and CNTs increased, making its surface more negatively charged, whereas NH₄⁺ was positively charged. Since the modified adsorbent and NH₄⁺ had a stronger electrostatic attraction than the individual AC, CNTs, and NH₄⁺, the quantity of ammonia nitrogen adsorbed to the modified adsorbents was greater. Further, the adsorbent surface carboxyl and phenolic groups fixed ammonia nitrogen to AC and CNTs. The characterization indicated that many metal oxides were introduced on the AC and CNT surface during impregnation. The metal cations interchange ions with NH₄⁺ on the AC and CNTs' surfaces, enhancing the NH₄⁺ adsorption capacity. The following chemical reactions may have taken place on the modified AC surface during the process of adsorbing ammonia nitrogen:

AC-Fe³⁺+3NH₄⁺→AC-(NH4⁺)₃+Fe³⁺

AC-Al³⁺+3NH₄⁺→AC-(NH4⁺)₃+Al³⁺

AC-Cu²⁺+3NH₄⁺→AC-(NH4⁺)₃+Cu²⁺

AC-Ag⁺+3NH₄⁺→AC-(NH4⁺)₃+Ag⁺

The same reactions for CNTs impregnated with different metal oxides:

CNT-Fe³⁺+3NH₄⁺→CNT-(NH4⁺)₃+Fe³⁺

CNT-Al³⁺+3NH₄⁺→CNT-(NH4⁺)₃+Al³⁺

CNT-Cu²⁺+3NH₄⁺→CNT-(NH4⁺)₃+Cu²⁺

CNT-Ag⁺+3NH₄⁺→CNT-(NH4⁺)₃+Ag³⁺

It may be concluded from the above results that the absorption of ammonia nitrogen involved both physical and chemical processes. Physical adsorption mainly included Van Der Waals and electrostatic adsorption, while chemical adsorption included functional group adsorption and ion exchange. A higher concentration of acidic functional groups results in a greater ability to absorb ammonia. Lewis and Bronsted acid sites may facilitate this absorption due to the lone pair of electrons. Here, two ammonia molecules form standard hydrogen bonds (NH-N) along the sinusoidal channel, while a third ammonia molecule interacts strongly with the Bronsted acid site to produce NH4⁺ species (O—⁺HN). Further, the presence of water plays an essential role in adsorption sites and mechanism pathways. Through cooperative interactions, the hydrogen bonding between water and ammonia improves the metal-ammonia contact. Furthermore, water encourages acidic group dissociation and ammonia protonation.

Aspects of the present disclosure are directed towards removing ammonia from wastewater. Modified AC and CNTs were studied in different metal impregnations having two different percentage loadings of metals, e.g., 1% and 10%. The results were compared with a pure form of these adsorbents. Different parameters such as pH, agitation speed, dosage of adsorbent, contact time, and temperature were varied to see their effect on removal efficiency. The results with the method of present disclosure indicate that a maximum removal of 40.3% was achieved by 10 wt. % Al impregnated AC with 1 g dosage, 10.5 pH, 200 RPM agitation speed, and 70° C. temperature. Further, it is followed by Fe and Cu, while silver oxide showed 10% removal at the same conditions. Furthermore, AC gave better results than CNTs, and all the results showed that AC with 10% loadings gave better removal results than 1% loadings of metals.

Numerous modifications and variations of the present disclosure are possible in light of the above teachings. It is therefore to be understood that within the scope of the appended claims, the invention may be practiced otherwise than as specifically described herein.

1. A method for removing ammonia from wastewater, comprising:
impregnating an activated carbon with an aluminum salt to obtain an impregnated activated carbon; and
mixing the impregnated activated carbon with the wastewater while agitating at a temperature of 65 to 75° C. to contact the impregnated activated carbon with the wastewater,
wherein during the mixing a first portion of the ammonia present in the wastewater is adsorbed on the impregnated activated carbon and a second portion of the ammonia present in the wastewater displaces a portion of the aluminum salt in the impregnated activated carbon to obtain a displaced impregnated activated carbon,
wherein the displaced impregnated activated carbon comprises 8 to 12 wt. % Al,
wherein wt. % is based on the total weight of the Al and the activated carbon,
wherein the Al present in the impregnated activated carbon is in the form of nanocrystals and the nanocrystals are at least partially embedded on a surface of the impregnated activated carbon, and
wherein the wastewater has a pH between 9 and 11.

2. The method of claim 1, wherein 0.05 to 2.0 g of the impregnated activated carbon is mixed with 100 mL of the wastewater.

3. The method of claim 1, wherein the nanocrystals have a diameter of 50 to 600 nanometers (nm).

4. The method of claim 1, wherein the impregnated activated carbon and the wastewater are mixed with an agitation speed of 100 to 250 RPM.

5. The method of claim 1, wherein the impregnated activated carbon comprises 10 wt. % Al,
wherein the mixing achieves an ammonia removal of 40 wt. % from the wastewater based on the total weight of the wastewater,
wherein the pH of the wastewater during the mixing is 10.5, and
wherein the mixing is conducted for 2 hours.

6. The method of claim 1, wherein 5% to 40% by volume of the nanocrystals are embedded on the surface of the impregnated activated carbon.

7. The method of claim 6, wherein the aluminum salt is aluminum nitrate.

8. The method of claim 1, wherein the activated carbon has an average particle diameter of 600 to 1000 nm.

9. The method of claim 4, wherein the mixing is at an agitation speed of 200 RPM.

10. The method of claim 1, wherein the Al-displaced impregnated activated carbon comprises 10 wt. % of Al.

11. The method of claim 1, wherein the wastewater has a pH of 10 to 11.

12. The method of claim 1, wherein the wastewater has a pH of 10.5.

13. The method of claim 1, wherein the impregnated activated carbon has a top surface and a bottom surface,
wherein the top and bottom surface are irregular in shape, and
wherein the impregnated activated carbon has a surface area of 500 to 1500 m²/g.

14. The method of claim 3, wherein the wastewater has a temperature of 70° C. during the mixing.

15. The method of claim 2, wherein 1.5 to 2 g of the impregnated activated carbon is mixed with 100 mL of the wastewater.

16. The method of claim 2, wherein 2 g of the impregnated activated carbon is mixed with 100 mL of the wastewater.

17. The method of claim 1, wherein the mixing is conducted for 2 to 4 hours.

18. The method of claim 1, wherein the mixing is conducted for 2 hours.
